(19) United States
(12) Patent Application Publication
(10) Pub. No.: US 2017/0277688 A1
(43) Pub. Date: Sep. 28, 2017

(54) IMAGE FILE GENERATING METHOD FOR DATA STORAGE DEVICE

(71) Applicant: Silicon Motion, Inc., Jhubei (TW)

(72) Inventor: Sheng-Yuan Huang, New Taipei (TW)

(21) Appl. No.: 15/427,013

(22) Filed: Feb. 7, 2017

(30) Foreign Application Priority Data
Mar. 28, 2016 (TW) 105109766
Apr. 15, 2016 (TW) 105111938

(51) Int. Cl. G06F 17/30; G06F 3/06

(52) U.S. Cl. CPC G06F 17/3012; G06F 17/3028; G06F 3/0604; G06F 3/0643; G06F 3/0673

(57) ABSTRACT

An image file generating method of a data storage device includes steps of: recording and storing a plurality of specific data into a plurality of data sectors, respectively; storing a plurality of initial data into at least one of the data sectors; performing a data comparison on stored data in the data sectors with the specific data respectively and recording a plurality of logical addresses corresponding to the stored data determined as the initial data; and generating an image file by recording the initial data and the logical addresses corresponding to the initial data.

### FIELD OF THE INVENTION

The present invention relates to an image file generating method, and more particularly to an image file generating method for a data storage device.

### BACKGROUND OF THE INVENTION

Conventionally, before the data storage devices such as hard drives or portable hard drives are sold to the consumers, the manufacturer would pre-store initial data such as texts, images, audio and video files or restore program in the to-be-sold data storage devices. In order to improve the production rate of the data storage devices, in the production process the manufacturer may store the initial data in the very first one manufactured data storage device and generate a corresponding image file according to the storing address of the initial data in this data storage device, so that the initial data can be quickly stored into the subsequently-manufactured data storage devices through the image file. However, according to the conventional image file generating mean, the block having non-null data is determined as a block stored with the initial data. Therefore, if the data storage device has been performed by randomizer before the initial data is written, the data storage device may already have blocks with non-null data; and consequently the image file may not be generated correctly. In addition, the file system format of the data storage device, such as file allocation table (FAT), extended file allocation table (exFAT), new technology file system (NTFS), etc., may not be supported by the manufacturers; therefore, the manufacturer may have to generate the image file for all the blocks. As a result, if the image file cannot be effectively compressed, the manufacturer may not be able to manufacture the data storage devices efficiently; and consequently, the manufacturer may suffer from high cost and losses in business.

### SUMMARY OF THE INVENTION

Accordingly, to generate a correct image file, one objective of the present invention is to provide an image file generating method of a data storage device. Further, when the file system format is not supported, the image file generating method of the present invention can effectively compress the size of the image file, thereby improving the production rate of the data storage device.

The present invention provides an image file generating method of a data storage device, which includes steps of: recording and storing a plurality of specific data into a plurality of pages, respectively; storing a plurality of initial data into at least one of the pages; performing a data comparison on stored data in the pages with the specific data respectively to obtain a plurality of addresses corresponding to the initial data; and generating an image file to record the initial data and the addresses corresponding to the initial data.

The present invention further provides an image file generating method of a data storage device, which includes steps of: recording and storing a piece of specific data into a plurality of blocks; storing at least one piece of initial data into at least one of the plurality of blocks; performing a data comparison to obtain a storing address of the at least one of the plurality of blocks; and generating an image file according to the at least one piece of initial data and the storing address of the at least one of the plurality of blocks.

The present invention still further provides an image file generating method for a data storage device, which includes steps of: storing a plurality of specific data into a plurality of pages of a plurality of blocks of the data storage device, respectively, and each specific data is corresponding to an address; storing a plurality of initial data into the pages and each of the initial data is also corresponding to the address; recording the address and the initial data in each of the pages storing the initial data but not the specific data; and generating an image file based on the recorded address and the recorded initial data.

### BRIEF DESCRIPTION OF THE DRAWINGS

Other advantages, objectives and features of the present invention will become apparent from the following description referring to the attached drawings.

FIG. 1 is a schematic block view of a system in accordance with an embodiment of the present invention;

FIG. 2 is a flowchart of an image file generating method in accordance with an embodiment of the present invention;

FIG. 3A is a schematic view of a plurality of blocks stored with respective specific data;

FIG. 3B is a schematic view of a plurality of blocks stored with respective initial data; and

FIG. 4 is a schematic view of an image file in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

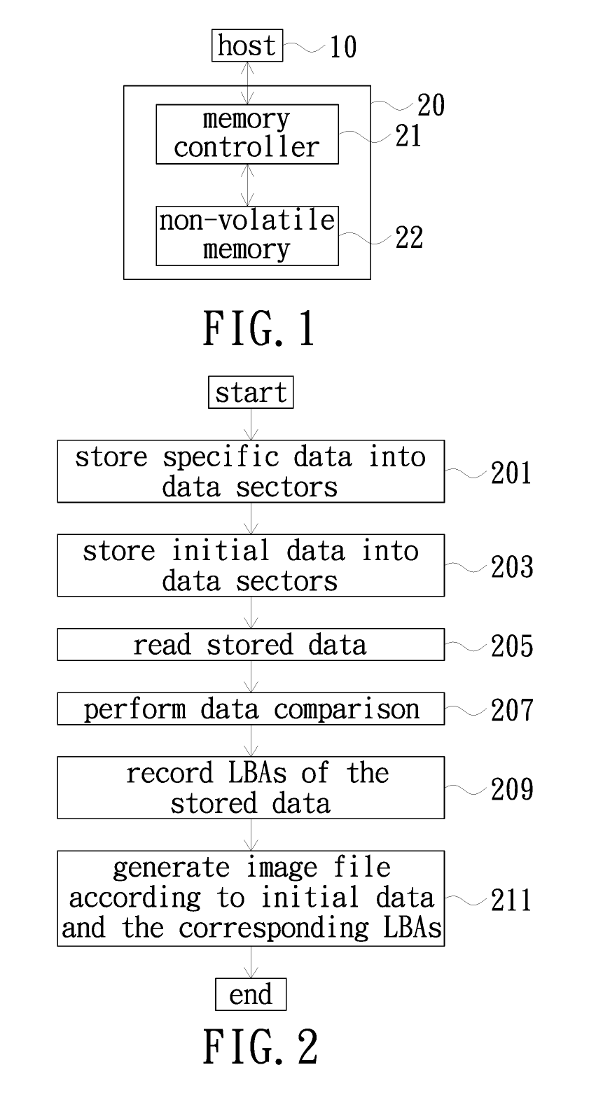

FIG. 1 is a schematic block view of a system in accordance with an embodiment of the present invention. As shown in FIG. 1, the system of the present embodiment includes a host 10 and a data storage device 20. The host 10 is electrically coupled to the data storage device 20 and may be an electronic device such as a desktop or a tablet computer. The data storage device 20 is configured to receive a write command or a read command issued from the host 10, write received data into the data storage device 20 according to the write command, or read data out from the data storage device 20 according to the read command. The data storage device 20 includes a memory controller 21 and a non-volatile memory 22. The memory controller 21 may be a microprocessor; and the non-volatile memory 22 may be a data storage medium such as a flash memory, a magnetoresistive random access memory (RAM) or a ferroelectric RAM capable of long-term data storage. The non-volatile memory 22 includes a plurality of blocks (not shown) for storing data. The memory controller 21 is electrically coupled to the non-volatile memory 22. The memory controller 21 is configured to receive the write command or the read command issued from the host 10, write the received data into the non-volatile memory 22 according to the write command, or read the data stored in the non-volatile memory 22 according to the read command.

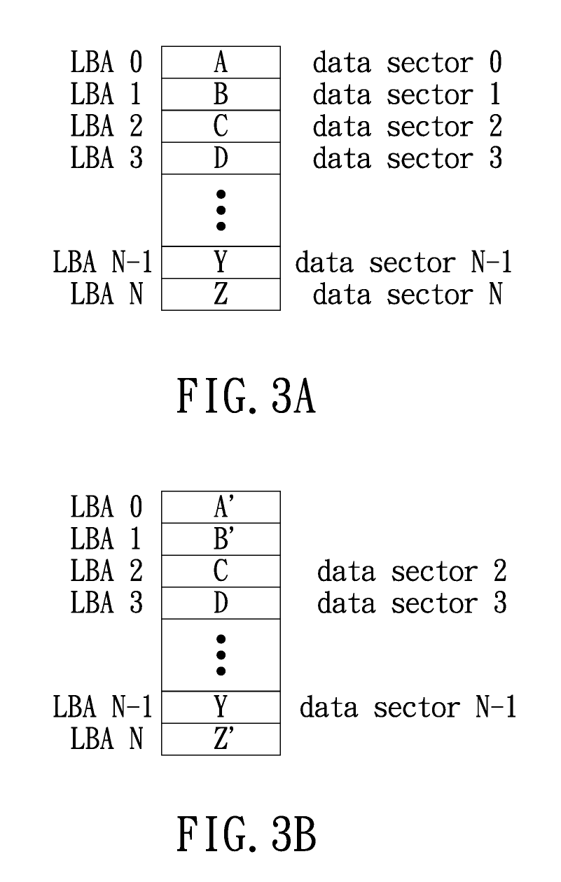

The following, in combination of FIGS. 1-3, describes an image file generating method in accordance with an embodiment of the present invention. As described above, the non-volatile memory 22 includes a plurality of blocks; and each block includes a plurality of pages. Each page has a storage capacity to store data, corresponding to a logical block address (LBA), in one preferred embodiment, that is, 512 bytes for the following description. However, it is to be understood that the storage capacity of the page is not limited in the present invention; that is, the storage capacity of the page is adjustable in response to an actual requirement and may be 4096 bytes or 64 bytes in another embodiment. FIG. 2 is a flowchart of an image file generating method in accordance with an embodiment of the present invention. First, in step 201, the host 10 records a plurality of specific data and requests the memory controller 21 to write the plurality of specific data into the plurality of pages of the non-volatile memory 22 according to the write commands, respectively. In one embodiment, the aforementioned specific data may be strings, numbers or random data generated in a random manner. As illustrated in FIG. 3A, among the aforementioned plurality of pages, each of which is written with the specific data corresponding to LBA 0, LBA 1, LBA 2, LBA 3, . . . , LBA N-1 and LBA N. Specifically, for example, page 0 is stored with specific data A corresponding to LBA 0; page 1 is stored with specific data B corresponding to LBA 1; the page 2 is stored with specific data C corresponding to LBA 2; the page 3 is stored with specific data D corresponding to LBA 3; ...; the page N-1 is stored with specific data Y corresponding to LBA N-1; and the page N is stored with specific data Z corresponding to LBA N. In the present embodiment, the LBA 0, LBA 1, LBA 2, LBA 3 . . . LBA N-1 and LBA N are indexes of the specific data stored in the respective pages. To reduce the time consumed by storing the specific data into the pages in step 201, the data size of the aforementioned specific data may be equal to the storage capacity of the page in one preferred embodiment. For example, each one of the aforementioned plurality of specific data may have a data size of 512 bytes, which is equal to the storage capacity of the page; and the present invention is not limited thereto.

Then, in step 203, the host 10 requests the memory controller 21 to write a plurality of initial data into the plurality of pages of the non-volatile memory 22 according to write commands, respectively. The aforementioned initial data may be parameters, texts, images, videos or codes that are to be pre-stored in the data storage device 20 by the manufacturer before shipping of the data storage device 20. Therefore, the stored specific data currently corresponding to at least one of the plurality of LBAs in the non-volatile memory 22 would be replaced by the written initial data. As illustrated in FIG. 3B, for example, once the initial data is written into the non-volatile memory 22, the specific data A corresponding to LBA 0 is changed to the initial data A′; the stored specific data B corresponding to LBA 1 is changed to the initial data B′; and the stored specific data Z corresponding to LBA N is changed to the initial data Z′.

Then, in step 205, the host 10 requests the memory controller 21 to read all the stored data currently stored in the non-volatile memory 22 (that is, the stored data stored in all of the pages) according to read commands.

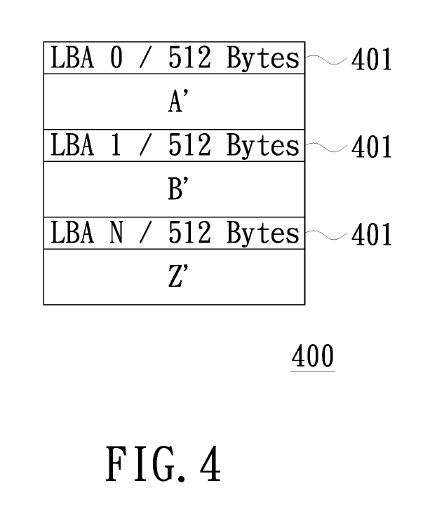

Then, in step 207, the host 10 performs a data comparison. Specifically, the host 10 compares the stored data stored in all of the pages with the specific data recorded in step 201 piece by piece. Herein the LBA 0 in FIGS. 3A and 3B is taken as an example. As shown, the stored data corresponding to LBA 0 is changed from the specific data A (FIG. 3A) to the initial data A′ as in step 203; and accordingly, the host 10 in step 207 determines that the stored data currently corresponding to LBA 0 is different from the specific data previously recorded in step 201. Therefore, in step 209, the host 10 records the addresses (LBA) corresponding to the data which is different from the respective specific data. As illustrated in FIG. 3B, for example, the host 10 determines the stored data corresponding to LBAs, including LBA 0, LBA 1 and LBA N, are replaced by the initial data. Then, in step 211, the host 10 generates an image file according to all the stored data which is replaced by the initial data in the non-volatile memory 22, the corresponding address(es) and the respective data sizes. As illustrated in FIG. 3B, for example, the stored data corresponding to addresses LBA 0, LBA 1 and LBA N is determined as the initial data as described above. Therefore, the host 10 records the addresses of LBA 0, LBA 1 and LBA N and the respective data sizes (e.g., 512 bytes) into the respective headers 401 of the stored data; further, the host 10 generates an image file 400 based on the stored data determined as the initial data and the respective headers 401 as illustrated in FIG. 4. Then, the image file generating method of the present embodiment is completed.

It is to be noted that it assumes all the data in the pages of the data storage device 20 is null before the initial data is written, in condition of the data storage device 20 does not perform the randomization on the stored data. Hence, in another embodiment, because all the data stored in the pages is null before the initial data is written, correspondingly step 201 can be omitted; the image file can be generated by executing only steps 203-211; and the data comparison in step 207 is realized by comparing the stored data in the pages with null piece by piece and determining whether the stored data is null.

In another embodiment, the possibility that the specific data and the initial data is completely identical is close to zero, thus, all the pages may be written with the same specific data (e.g., the specific data A) in step 201 and consequently the initial data is determined by comparing the stored data currently stored in the pages with the specific data A in step 207.

In addition, according to the results of simulation, the initial data may only occur in a particular address(es) and the possibility of the remaining addresses storing the initial data is extremely low or even zero. Thus, in another embodiment, the specific data may be written into only some particular or all of the addresses but the data comparison in step 207 is only performed for the particular address(es) possibly storing the initial data. Consequently, the time for the data comparison is reduced.

Once the image file 400 is generated according to the image file generating method of the present invention, the manufacturer can quickly pre-store each piece of the initial data, the respective storing address and the respective data size into a plurality of data storage devices 20 according to the generated image file 400. Therefore, regardless of whether the data storage devices 20 have performed the randomizer or the manufacturer does not support the current file system format set in the data storage devices 20, the storage of the initial data can be easily performed through the image file 400; and consequently, the manufacturing cost is effectively reduced and the commercial benefit is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image file generating method for a data storage device, comprising steps of:
recording and storing a plurality of specific data into a plurality of data sectors, respectively;
storing a plurality of initial data into at least one of the data sectors;
performing a data comparison on stored data in the data sectors with the specific data respectively and recording a plurality of logical addresses corresponding to the stored data determined as the initial data; and
generating an image file by recording the initial data and the logical addresses corresponding to the initial data.

2. The image file generating method according to claim 1, wherein an amount of the data sectors performed by the data comparison is less than an total amount of the data sectors.

3. The image file generating method according to claim 1, wherein the step of performing a data comparison on the stored data in the data sectors with the specific data respectively and recording a plurality of logical addresses corresponding to the stored data determined as the initial data comprises steps of:
determining whether the stored data currently stored in the pages corresponding to the LBAs are identical to the specific data, respectively; and
if false, determining the stored data in the data sectors as the initial data and recording the logical addresses corresponding to the stored data .

4. The image file generating method according to claim 1, wherein the specific data are specific strings, specific numbers or random data.

5. The image file generating method according to claim 1, wherein the initial data are parameters, texts, images, videos or codes.

6. The image file generating method according to claim 1, wherein the data storage device comprises a non-volatile memory, the non-volatile memory comprises a plurality of data blocks and each of the data blocks comprise the data sectors, and the specific data are stored in the data sectors, respectively.

7. The image file generating method according to claim 1, wherein a data size of each of the specific data is equal to a storage capacity of each of the data sectors.

8. The image file generating method according to claim 1, wherein the image file further records a data size of each of the initial data.

9. An image file generating method for a data storage device, comprising steps of:
recording and storing a piece of specific data into a plurality of data sectors;
storing a plurality of initial data into at least one of the data sectors;
performing a data comparison to obtain a plurality of logical addresses of the initial data; and
generating an image file according to the initial data and the logical addresses of the initial data.

10. The image file generating method according to claim 9, wherein an amount of the initial data performed by the data comparison is less than an amount of the specific data.

11. An image file generating method for a data storage device, comprising steps of:
storing a plurality of specific data into the data storage device;
storing a plurality of initial data into the data storage device;
recording a plurality of logical addresses of the initial data by performing a data comparison on the stored data of the data storage device with the specific data; and
generating an image file based on the recorded logical addresses and the initial data one by one.

12. The image file generating method according to claim 11, wherein the initial data are parameters, texts, images, videos or codes.

13. The image file generating method according to claim 11, wherein the specific data is specific strings, specific numbers or random data.

14. The image file generating method according to claim 11, wherein an amount of the initial data is less than an amount of the specific data.

15. The image file generating method according to claim 11, wherein the image file further records a data size of each of the initial data.
